(19) United States
(12) Patent Application Publication
(10) Pub. No.: US 2011/0264933 A1
(43) Pub. Date: Oct. 27, 2011

(54) METHOD AND APPARATUS FOR OPTIMAL ALLOCATION OF OPERATING POWER ACROSS MULTIPLE POWER DOMAINS OF A HANDHELD DEVICE

(76) Inventor: Lawrence David Forsythe, Milton (CA)

(21) Appl. No.: 12/765,912

(22) Filed: Apr. 23, 2010

(51) Int. Cl. G06F 1/32; H02J 1/14; G06F 3/048

(52) U.S. Cl. 713/320; 715/810; 307/39; 713/300

(57) ABSTRACT

A method and apparatus for power management in a handheld device having various power domains, including an attachable/detachable peripheral device. The power source has an available power amount. The method comprises receiving an indication of a power management event at the handheld device related to operation of a power domain, identifying a predetermined power signature associated with operation of the power domain, determining whether the available power amount is sufficient to operate the power domain in accordance with the predetermined power signature, reducing a power state of another functional upon determining that the available power is insufficient, and allocating the reduced power amount to the first power domain of the handheld device for operation according to the predetermined power signature.

### FIELD

The present disclosure relates generally to a method and apparatus for power management pertaining to a mobile handheld device.

### BACKGROUND

Given the proliferation of handheld mobile computing devices, power management has become an important factor in enhancing their usefulness. The availability of a wide number of peripheral devices has also contributed to the widespread adoption of handheld computers. Available peripheral devices may include barcode laser scanners, digital photo and document scanners, Global Positioning System (GPS) receivers, MPEG audio layer 3 (MP3) players and digital cameras, and much more. Such peripheral devices require electrical power for their operation.

Under certain circumstances, a need for simultaneous operation of multiple attached peripheral devices necessarily results in competition among those peripheral devices and other functional subsystems of the handheld computer device for the electrical power available from a finite source, such as a battery source, for example, that powers the handheld device. To the extent that the handheld device may be able to share electrical power with electrically coupled peripheral devices in a manner that optimizes operation and functioning of all devices involved, the utility of the system to a user is enhanced.

### SUMMARY OF THE INVENTION

Provided is a method of providing power management for a handheld device powered by a battery, the battery having an available power amount, the handheld device comprising a plurality of power domains, the method comprising receiving an indication of a peripheral device being attached at an expansion port of the handheld device; identifying a predetermined power signature associated with operation of the peripheral device; determining whether the available power is sufficient to operate the peripheral device via the expansion port in accordance with the predetermined power signature, reducing a power state of at least one of the plurality of power domains upon determining that the available power is insufficient to operate the peripheral device via the expansion port, and allocating the reduced power from reducing the power state of the at least one power domain for operation of the peripheral device via the expansion port, whereby the peripheral device is operable in accordance with the predetermined power signature.

Also provided is a handheld device comprising a processor, an expansion port for coupling peripheral devices coupled to the handheld device, the expansion port coupled to the processor, a plurality of power domains, a battery power source comprising an available power amount, and a memory coupled to the processor having instructions stored thereon for execution by the processor, the memory comprising instructions for receiving an indication of a peripheral device being attached at an expansion port of the handheld device, identifying a predetermined power signature associated with operation of the peripheral device, determining whether the available power amount is sufficient to operate the peripheral device via the expansion port in accordance with the predetermined power signature, reducing a power state of at least one of the plurality of power domains upon determining that the available power is insufficient to operate the peripheral device via the expansion port in accordance with the predetermined power signature, and allocating the reduced power from reducing the power state of the at least one power domain for operation of the peripheral device via the expansion port, whereby the peripheral device is operable in accordance with the predetermined power signature.

### BRIEF DESCRIPTION OF THE DRAWINGS

Embodiments will now be described by way of example only, with reference to the following drawings in which:

FIG. 1 illustrates an exemplary handheld device having port expansion functionality for peripheral devices and power management capability;

FIG. 2 is an exemplary conceptual diagram illustrating an embodiment of the functional subsystems and power domains of the handheld device, including port expansion power domains;

FIG. 3 illustrates a flowchart of an exemplary power management scheme of the handheld device; and

FIG. 4 illustrates a flowchart of an exemplary power management scheme tailored to a peripheral device having partial self-contained power capability, for attachment to the handheld device via an expansion port.

### DETAILED DESCRIPTION

As used herein, the term “power management” refers to a set of hardware, firmware, and system software, employed in any combination thereof to accomplish optimal, efficient allocation and utilization of electrical power supplied by a power source of a handheld device in continuing to meet the computational needs of the user of the device. The computational needs of the user may involve, for instance, a desire for simultaneous operation, or partially simultaneous operation, of the different functional subsystems, such as the display screen, keyboard input, and peripheral expansion ports, of the handheld device. Operation in such a manner necessarily results in competition among those functional subsystems for the electrical power available from a finite source, such as a battery source, for example, that powers the handheld or mobile device.

The goal of power management in this context, then, is to provide the optimal allocation of available power among the competing functional subsystems of the handheld device in a manner which is aligned with the needs and priorities of the user of the device a given point in time. Furthermore, doing so in a manner which is unobtrusive and convenient to the user, to the extent possible.

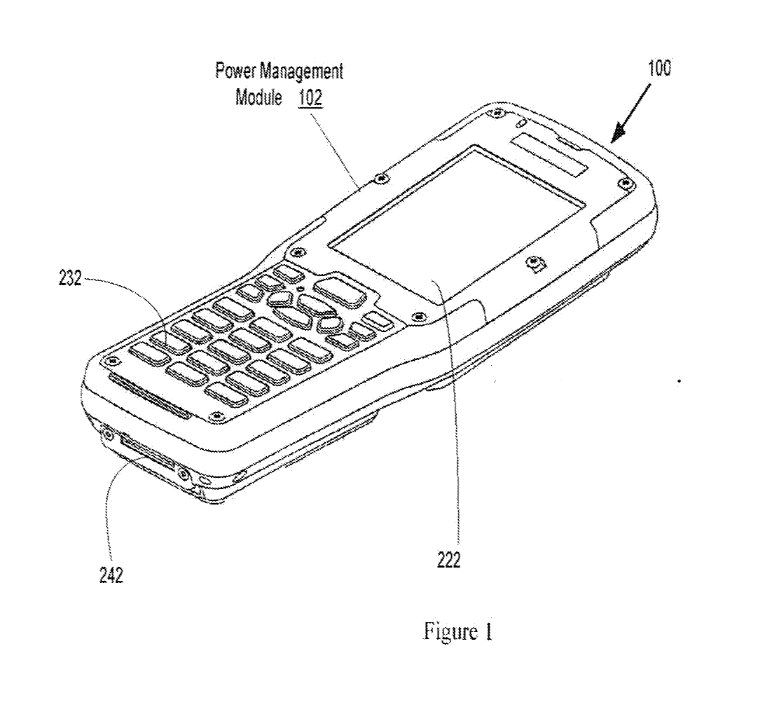

Referring now more particularly to the accompanying figures, FIG. 1 illustrates an exemplary embodiment of a handheld personal computer (herein referred to interchangeably as a handheld device, a mobile computer, or a mobile device) in accordance with the disclosure herein. The handheld computer may have the capability of communicating at least data, possibly both data and audio such as voice, to and from servers as well as data acquisition sources within a communication network.

Power management module 102, described in further detail below, may comprise a set of hardware, firmware, and system software, employed in any combination thereof to accomplish optimal and efficient allocation and utilization of electrical power supplied by a power source of the handheld device in meeting the computational or data communication needs of the user of the device. Expansion port 242 may be an exemplary Universal Serial Bus (USB) port or other similar expansion port for coupling compatible peripheral devices, such as, but not limited to, a digital scanner device or a communication and synchronization cradle for the handheld device.

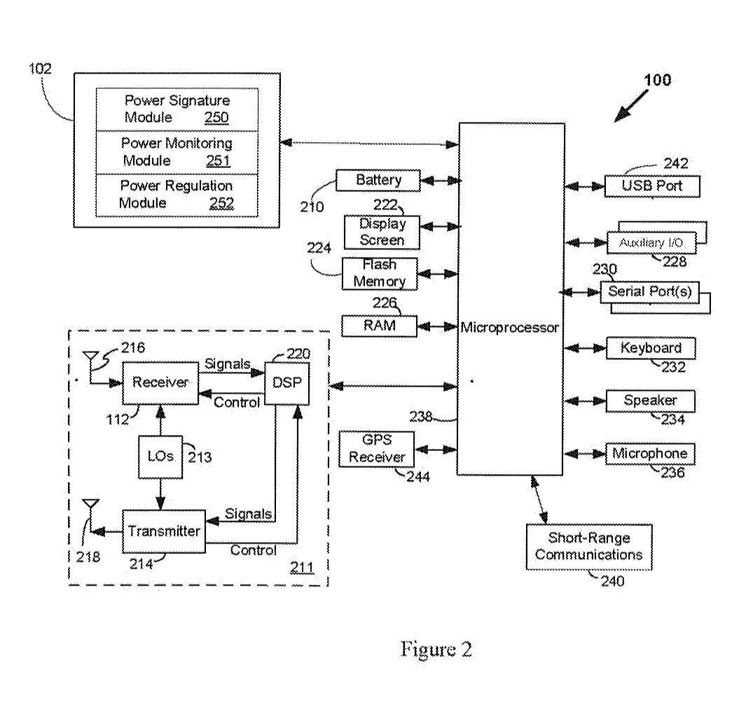

Referring now to FIG. 2, the handheld device 100 may include a radio frequency (RF) communication subsystem 211, which includes a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the RF communication subsystem 211 depends on the communication network in which handheld device 100 is intended to operate, but may include communication functionalities such as radio-frequency identification (RFID), Wi-Fi WLAN based on 802.11 standards, and the like.

The handheld device 100 includes a microprocessor 238 which controls general operation of the handheld device 100. The microprocessor 238 also interacts with functional device subsystems such as a display 222, a flash memory 224, a random access memory (RAM) 226, auxiliary input/output (I/O) subsystems 228, a serial port 230, a keyboard 232, a speaker 234, a microphone 236, a short-range communications subsystem 240 such as Bluetooth™ for example, and a Universal Serial Bus (USB) expansion port 242 for peripheral. Serial port 230 may be capable of accommodating a scheme for a stacked series of peripheral devices or other expansion functions, representing a stacked load. The handheld device 100 may include a power source 210, such as a rechargeable battery which may also be removable and replaceable from the handheld device. The handheld device 100 may also include a positioning device 244, such as a GPS receiver for example, for receiving positioning information.

Operating system software used by the microprocessor 238 may be stored in a persistent store such as the flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

The microprocessor 238, in addition to its operating system functions, enables execution of software applications on the handheld device 100. A predetermined set of applications, which control basic device operations, may be installed on the handheld device 100 during its manufacture. These basic operations typically include data and voice communication applications, for example. Additionally, applications may also be subsequently loaded onto the handheld device 100 through the communication subsystem 211, an auxiliary I/O subsystem 228, serial port 230, USB port 242, short-range communications subsystem 240, or any other suitable subsystem, and installed by a user in RAM 226, or the persistent store 224, for execution by the microprocessor 238. Such flexibility in application installation increases the functionality of the handheld device 100 and may provide enhanced on-device features, communication-related features, or both.

The display screen 222 is used to visually present an application's graphical user interface (GUI) to the user. The user can manipulate application data by modifying information on the GUI using an input device such as the keyboard 232 for example. Depending on the type of handheld device 100, the user may have access to other types of input devices, such as, for example, a scroll wheel, trackball, light pen or touch sensitive screen.

The handheld device subsystems discussed in the preceding few paragraphs may be somewhat regarded as distinct functional subsystems. For instance, the display screen 222, the keyboard 232, the USB expansion port 242, the serial expansion port 230, the RF communication subsystem 211 may be regarded as functional subsystems directed to performing a distinct or identifiable function of the handheld device 100. Thus, the term functional subsystem used herein refers to a component or a grouping of components which are capable of performing an identifiable or distinct function pertaining to operation of the handheld device. Furthermore, each individual functional subsystem as described herein requires electrical power for its functioning, consumes electrical power during its operation, and hence may be considered its own distinct power domain.

Power management module 102 may comprise power signature module 250, power monitoring module 251 and power regulation module 252.

Power Signature Module 250 may comprise essentially a lookup table stored in any of device flash memory 224, RAM 226, and in which the power-related characteristics of the various power domains of the handheld device are tabulated, including for pre-determined compatible peripheral devices capable of attachment and operation with the handheld device. Power-related characteristics may comprise, for example, power consumption during the ON state, the OFF state (if applicable), and voltage and current operating characteristics. Such power-related characteristics are typically pre-determined by the manufacturer of a given peripheral device or of a functional subsystem (such as display screen 222, keyboard 232, for example) of the handheld device, and are published in the respective manufacturer's specifications. In cases where power-related characteristics may not be available from a manufacturer, calibration techniques for mapping and determining electrical power, voltage and current characteristics of any of the above-discussed functional subsystem, and thus the respective power domain, of handheld device 100 are well known in the art, and may be applied.

Techniques for automatically detecting attachment of a peripheral device into an expansion port of a handheld computer are well know in art, for instance using interrupt lines from the processor 238 to the expansion ports 242, 230, 228 such that processor 238 can detect when a peripheral device has been inserted or removed. Similarly well known in the art are techniques for automatically identifying compatible peripheral devices at the time of their attachment to a handheld device via peripheral expansion ports, for example via USB port 242, serial port 230, or auxiliary I/O port 228. Thus, upon attachment of a compatible peripheral device to handheld device 100, the power characteristics of the peripheral device, as pre-determined and recorded in power signature module 250, would be accessible to processor 238 of handheld 100.

Power monitoring module 251 provides the ability to monitor the power draw during operation of any power domain or attached peripheral device of handheld device 100. The measurements of actual power draw may be based on monitoring of current flow measurements within the various power domains by power monitoring module 251 are accessible to processor 238 of handheld device 100.

Power monitoring module 251 may also be used to continuously sample and keep track of the power available from a battery source being used to power the functional subsystems/power domains of device handheld 100. Thus, as the battery power may be depleted continuously during operation of the handheld device 100, power monitoring module keeps track of the available amount of power remaining at any given time across all power domains.

Power regulation module 252 provides the ability to change the power consumption state of a power domain of the handheld device 100 or of a peripheral device, in order to allocate, or re-allocate if necessary, electrical power amongst the various power domains including peripheral expansion ports. This may be accomplished using any combination of electronic hardware (voltage regulators, current regulating components, and on/off circuits and switches, for example), firmware and software. Changing the power consumption state may comprise, in the extreme, switching a power domain or attached peripheral device from an OFF state to an ON state, and vice versa.

In other cases, changing the power consumption state may comprise ramping up, or ramping down, the power consumption, without switching to an extreme ON or OFF state. For example, display screen 222 may be suitably dimmed to reduce its power consumption in order that the reduced power may be re-allocated or made available to another power domain of handheld device 100 which is invoked or initiated by the user, such as upon attachment of a peripheral device to any of expansion ports 242, 230, 228. In another example, processor 238 may be ramped down to a slower processor cycle rate, or even switched to a sleep mode, in order to reduce its power consumption, whereby that reduced amount of power can be re-allocated and re-directed by power regulation module 252 towards operation of the power domain being invoked by the user.

It is contemplated that power regulation module 252 may be programmed with rules for determining which power domains are ramped down or switched off in power usage, and also in what order or priority these changes in power state are applied to the power domains that will be affected. The rules, or priority of operation, as programmed in power regulation module 252 may be determined by a user or a system administrator of handheld device 100. Alternatively, the user may be presented with the opportunity to select, via a user input action at the handheld device, the order or priority for reducing power among the plurality of the power domains.

In another variation, in lieu of programmed rules for automatic operation, power management module 102 may work in conjunction with processor 238 and the operating system software of handheld device 100 to present the user with options, such as via a software menu list displayed on display screen 222, for selecting which power domains should be ramped down or switched off, and in what order, upon detection of a power management event.

In yet another variation, it is contemplated that some hybrid of the automatic rules and manual user selection, discussed immediately above, may be implemented.

Viewed another way, upon a user of handheld device 100 initiating a power management event, one or more of the power domains may be subjected to reduced/increased power, switched off/on power, or any appropriate combination thereof. The term power management event as used herein means receiving an indication that the user of handheld device 100 wishes to invoke any one, or several, of the plurality of functional subsystems in a manner which changes, or will change, the power state of the respective power domain(s) invoked.

A power management event may be automatic, or automatically inferred, or example, by the act of a user in attaching a peripheral digital scanner device via USB port 242 of handheld device 100 comprises a power management event, since operation of the scanner will require a power draw, for instance from a depleteable battery source of handheld device 100, for its operation.

It is also contemplated that a power management event may be manually initiated. For example, the user may be presented with a list of functional subsystems, or applications requiring usage of certain power domains, such as via a software menu list graphically displayed on displayed screen 222. In this case, the user may proceed to select any of the choices given, in order to invoke a particular application in conjunction with a related power domain for immediate usage.

In another variation of the automatic power management event scenario discussed above, the peripheral digital scanner device attached by the user may include its own self-contained power source, typically a battery. Upon attachment of the peripheral digital scanner device to an expansion port 242, 230 of handheld device 100, power monitoring module may be programmed to test the power state of the peripheral digital scanner device in order to determine the amount of its self-contained power remaining.

However, power monitoring module 251 in conjunction with processor 238 may determine that the power available or remaining in that self-contained source is not sufficient to power the peripheral digital scanner device for operation via the expansion port. In such case, it is contemplated that processor 238 in conjunction with power management module 102 may determine the deficit in power draw attributable to proper operation of the peripheral digital scanner, and draw at least that amount of power from the battery source of handheld device 100, for operation of the peripheral device via the expansion port.

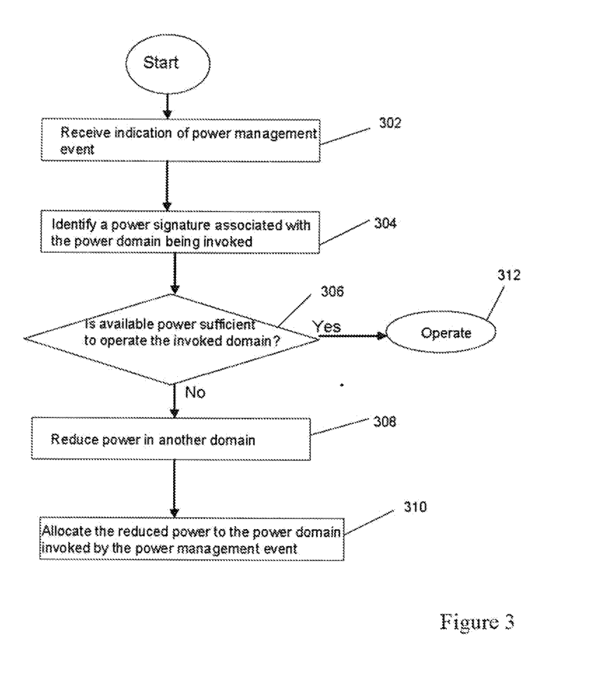

FIG. 3 illustrates a flowchart of an exemplary power management scheme of the handheld device 100. At step 302, there is received an indication of a power management event at the handheld computer. At step 304, power signature module 250 is used to determine a power signature of the power domain associated with the power management event. At step, 306, it is determined whether the power available from the power source of handheld device 100 is sufficient to operate the power domain invoked by a user of the handheld device 100. At step 312, if the power is sufficient, then operation of the invoked subsystem may be commenced. At step, 308, if the power available is not sufficient, then the power is reduced in another of the currently operating power domains. At step 308, the reduced power is allocated and redirected for operation of the invoked power domain. Steps 308 and 310 may be repeated with regard to another power domain, such that the cumulative reduced power will be at least sufficient for operation of the invoked power domain.

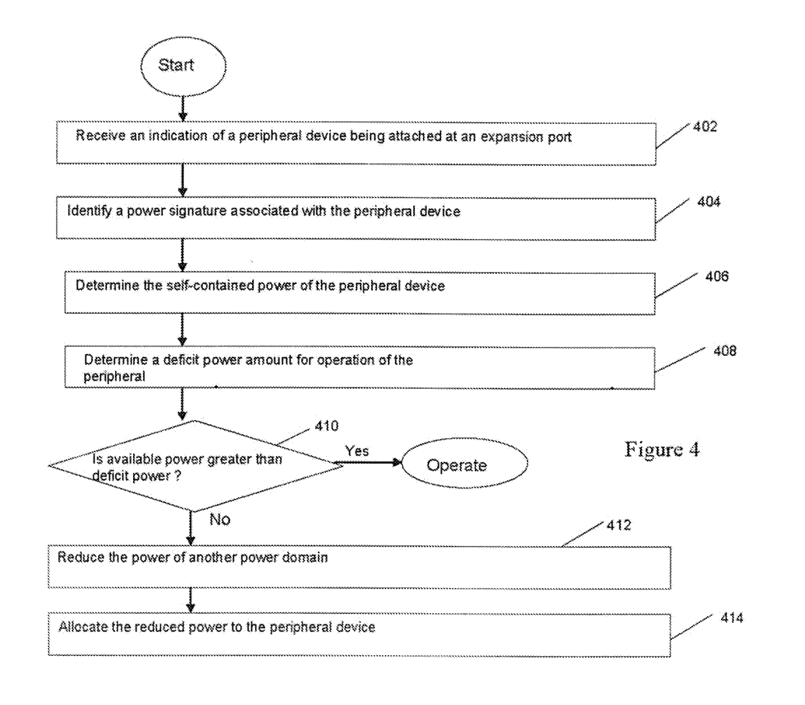

FIG. 4 illustrates a flowchart of an exemplary power management scheme tailored to a peripheral device having at least a partial self-contained power capability, for attachment to the handheld device via an expansion port. At step 402, there is received an indication of a peripheral device being attached to an expansion port. At step 404, the power signature module 250 is used to determine the power signature associated with the identified peripheral device. At step 406, processor 238 determines the self-contained power amount of the peripheral device. At step 408, the deficit power amount required for operation of the peripheral device via the expansion port is determined. At step 410, a determination is made as to whether the available power amount at the battery power source of handheld device 100 is greater than the deficit power amount. At step 412, only if that determination results in a negative answer is the power of another power domain reduced. At step 414, the power from the power reduction is re-allocated to operation of the peripheral device.

Although a mobile or handheld computer has been used to establish a context for disclosure herein, it is contemplated as having much wider applicability within the field of power management. Furthermore, the disclosure herein has been described with reference to specific exemplary embodiments; however, varying modifications thereof will be apparent to those skilled in the art without departing from the scope of the invention as defined by the appended claims.

What is claimed is:

1. A method of providing power management for a handheld device powered by a power source, the power source having an available power amount, the handheld device comprising a plurality of power domains, the method comprising:
receiving an indication of a power management event at the handheld device related to operation of a first power domain of the plurality of power domains;
identifying a predetermined power signature associated with operation of the first power domain;
determining whether the available power amount is sufficient to operate the first power domain in accordance with the predetermined power signature;
reducing a power state of at least a second power domain of the plurality of power domains upon determining that the available power is insufficient to operate the first power domain in accordance with the predetermined power signature; and
allocating the reduced power from reducing the power state of the at least a second power domain to the first power domain of the handheld device;
whereby the first power domain of the handheld device is operable in accordance with the predetermined power signature.

2. The method of claim 1 wherein the power source of the handheld device comprises at least one battery.

3. The method of claim 1 wherein the power management event comprises attachment of a peripheral device to a peripheral expansion port of the handheld device, and the first power domain comprises the peripheral expansion port.

4. The method of claim 1 wherein the power management event comprises selection of a peripheral device for operation from among a menu list of choices presented at the graphical display screen of the handheld device, and the first power domain comprises a peripheral expansion port.

5. The method of claim 1 wherein the at least a second power domain is selected from the plurality of power domains according to predetermined rules regarding priority of operation.

6. The method of claim 1 wherein the at least a second power domain is selected from the plurality of power domains by a user input action received at the handheld device.

7. A method of providing power management for a handheld device powered by a battery, the battery having an available power amount, the handheld device comprising a plurality of power domains, the method comprising:
receiving an indication of a peripheral device being attached at an expansion port of the handheld device;
identifying a predetermined power signature associated with operation of the peripheral device;
determining whether the available power is sufficient to operate the peripheral device via the expansion port in accordance with the predetermined power signature;
reducing a power state of at least one of the plurality of power domains upon determining that the available power is insufficient to operate the peripheral device via the expansion port in accordance with the predetermined power signature; and
allocating the reduced power from reducing the power state of the at least one power domain for operation of the peripheral device via the expansion port;
whereby the peripheral device is operable in accordance with the predetermined power signature.

8. The method of claim 5, wherein receiving an indication of a peripheral device being attached at an expansion port comprises receiving a selection for a peripheral device to be operated from among a software menu of options presented at a display screen of the handheld device.

9. The method of claim 7, wherein the expansion port comprises a serial port.

10. The method of claim 9, wherein the serial port comprises capability to accommodate a stacked load, the stacked load comprising a stacked series of expansion device functions.

11. A method of providing power management for a handheld device powered by a battery, the battery having an available power amount, the handheld device comprising a plurality of power domains, the method comprising:
receiving an indication of a peripheral device being attached at an expansion port of the handheld device, the peripheral device having a self-contained power amount;
identifying a predetermined power signature associated with operation of the peripheral device;
testing the attached peripheral device to determine the self-contained power amount;
determining a deficit power amount for operation of the peripheral device via the expansion port in accordance with the predetermined power signature;
determining whether the available power is greater than the deficit power amount to operate the peripheral device via the expansion port in accordance with the predetermined power signature;
reducing a power state of at least one of the plurality of power domains by an amount at least equal to the difference of the deficit power amount and the available power amount if it is determined that the available power is lesser than the deficit power amount; and
allocating the reduced power from reducing the power state of the at least one power domain for operation of the peripheral device via the expansion port;
whereby the peripheral device is operable in accordance with the predetermined power signature.

12. The method of claim 11, wherein receiving an indication of a peripheral device being attached at an expansion port comprises receiving a selection for a peripheral device to be operated from among a software menu of options presented at a display screen of the handheld device.

13. The method of claim 11, wherein the expansion port is a serial port.

14. The method of claim 13, wherein the serial port comprises capability to accommodate a stacked load, the stacked load comprising a stacked series of expansion device functions.

15. A handheld device comprising:
a processor;
an expansion port for coupling peripheral devices coupled to the handheld device, the expansion port coupled to the processor;
a plurality of power domains;
a battery power source comprising an available power amount; and
a memory coupled to the processor having instructions stored thereon for execution by the processor, the memory comprising instructions for:
receiving an indication of a peripheral device being attached at an expansion port of the handheld device;
identifying a predetermined power signature associated with operation of the peripheral device;
determining whether the available power amount is sufficient to operate the peripheral device via the expansion port in accordance with the predetermined power signature;
reducing a power state of at least one of the plurality of power domains upon determining that the available power is insufficient to operate the peripheral device via the expansion port in accordance with the predetermined power signature; and
allocating the reduced power from reducing the power state of the at least one power domain for operation of the peripheral device via the expansion port;
whereby the peripheral device is operable in accordance with the predetermined power signature.

16. The handheld device of claim 15, wherein the expansion port comprises a serial port.

17. The handheld device of claim 15, wherein the battery power source comprises a rechargeable, removable battery.
